(19) United States
(12) Patent Application Publication
(10) Pub. No.: US 2026/0259987 A1
(43) Pub. Date: Sep. 3, 2026

(54) ENHANCING DEVICE SECURITY THROUGH DEVICE REFRESH

(71) Applicant: MASTERCARD TECHNOLOGIES CANADA ULC, Vancouver (CA)

(72) Inventors: Nicole Deanne HATHAWAY, St. Peters, MO (US); Abhishek JAYANTH, Surrey (CA); Shahbaz SOOMRO, Innisfil (CA); Tammy HALE, Arnold, MO (US); Terry BIBB, Marthasville, MO (US)

(21) Appl. No.: 19/069,174

(22) Filed: Mar. 3, 2025

(51) Int. Cl. G06F 21/57

(52) U.S. Cl. CPC G06F 21/57

(57) ABSTRACT

A computerized system and method for enhancing device security through device refresh is provided. A device eligible for refresh is identified. A message is automatically sent to a user associated with the identified device. The message includes step-by-step instructions to the user to upgrade the device. It is automatically determined whether a request has been received from the user to upgrade the device with a replacement device within a predetermined time period (e.g., of sending the message). Upon determining that a request has not been received from the user to upgrade the device within the predetermined time period, a service is automatically deactivated on the device. Upon determining that a request has been received from the user to upgrade the device within the predetermined time period, a process is automatically initiated for providing the replacement device to the user.

### BACKGROUND

In an era dominated by rapid technological advancements and ubiquitous connectivity, device security has become a critical concern for individuals and organizations alike. Cyber threats such as malware, ransomware, and unauthorized access continue to evolve, exploiting vulnerabilities in outdated systems and devices. A major challenge in maintaining device security is ensuring that devices remain updated with the latest software patches, configurations, and security protocols. Regular device refresh (e.g., replacing, updating, or reconfiguring devices) plays a crucial role in addressing hardware and software obsolescence, closing security gaps, and enhancing overall system reliability. However, existing refresh processes are often time-consuming, error-prone, and resource-intensive, leaving organizations exposed to potential security breaches.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized system and method for enhancing device security through device refresh is provided. A device eligible for refresh is identified. A first message is automatically sent to a user associated with the device eligible for refresh. The first message includes step-by-step instructions to the user to upgrade the device. It is automatically determined, from upgrade data obtained from an upgrade database, whether a request has been received from the user to upgrade the device with a replacement device within a first predetermined time period of sending the first message. Upon determining that a request has not been received from the user to upgrade the device within the first predetermined time period, a service is automatically deactivated on the device. Upon determining that a request has been received from the user to upgrade the device within the first predetermined time period, a process is automatically initiated for providing the replacement device to the user.

### BRIEF DESCRIPTION OF THE DRAWINGS

The present description will be better understood from the following detailed description read considering the accompanying drawings, wherein:

FIG. 1 is a block diagram illustrating an example system for enhancing device security by automating device refresh;

FIG. 2A is a block diagram illustrating an example notification notifying a user eligible for a device refresh;

FIG. 2B is a block diagram illustrating an example notification notifying a user with instructions to enroll the replacement device and instructions to return the old device;

FIG. 3A-3E are example user interfaces for tracking automated device refresh;

FIGS. 4A and 4B are flowcharts illustrating an example method for enhancing device security by automating device refresh; and

FIG. 5 illustrates an example computing apparatus as a functional block diagram.

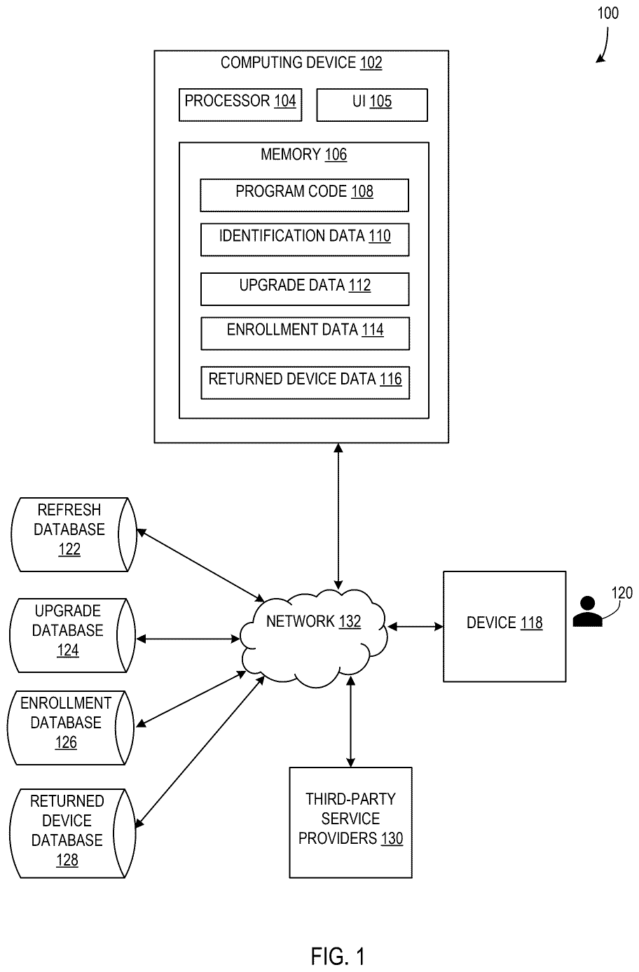

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Device refresh is a critical aspect of maintaining the security, reliability, and performance of any technological ecosystem. It involves updating, replacing, or reconfiguring devices to: address hardware or software obsolescence, improve operational efficiency, and ensure compliance with evolving security standards. By prioritizing device refresh, organizations can protect themselves against evolving threats, enhance operational efficiency, and maintain a competitive edge in today's fast-paced digital landscape. It is not merely a technological upgrade but a strategic investment in security, productivity, and long-term sustainability. However, in an organization having hundreds or thousands of users, ensuring adherence to the organization's device refresh policy and lifecycle is difficult and prone to errors.

Examples of the disclosure solve this technical problem and others at least by enhancing device security with automated device refresh. The complete lifecycle of the device refresh process is automated including, for example: identifying a device eligible for refresh, notifying a user if the device is eligible for refresh, automatically determining if the user has requested for device refresh based on the notification, sending reminder(s) if the user does not request for upgrading the device with a replacement device within a predetermined time period, sending instructions to configure the replacement device and/or return the device, sending reminders to configure the replacement device, automatically determining if the user has configured the replacement device, automatically determining if the user has returned the device, automatically deactivating a service on the device if the user does not configure the replacement device and/or does not return the device, and automatically activating the service on the replacement device if the user configures the replacement device and/or returns the device.

Aspects of the disclosure operate in an unconventional way at least by leveraging data analytics and artificial intelligence (AI) to identify eligible devices, send timely messages and/or reminder messages, ensure consistent device refresh adhering to organizational refresh policy and security standards, and reduce risks associated with oversight or delays-all without human involvement. Examples of the disclosure evaluate device health, usage patterns, and security status to determine when a refresh is genuinely required. This ensures computing resources are used efficiently thereby avoiding wasting resources on device refresh if it is not required. Further, automated activation and/or deactivation of services on the replacement device and/or the device respectively ensures device security eliminating unwanted security incidents that may occur because of an outdated device due for refresh. In some examples, return of the device being refreshed is ensured before or after activation of the replacement device, thereby ensuring that the device is appropriately disposed of by authorized agency which promotes recycling and resource recovery from the device (e.g., it may be reused in manufacturing new devices) and practices environment friendly disposal. By refreshing devices responsibly and disposing of old ones in an eco-conscious manner, organizations can play a vital role in reducing e-waste, conserving natural resources, and fostering a sustainable future.

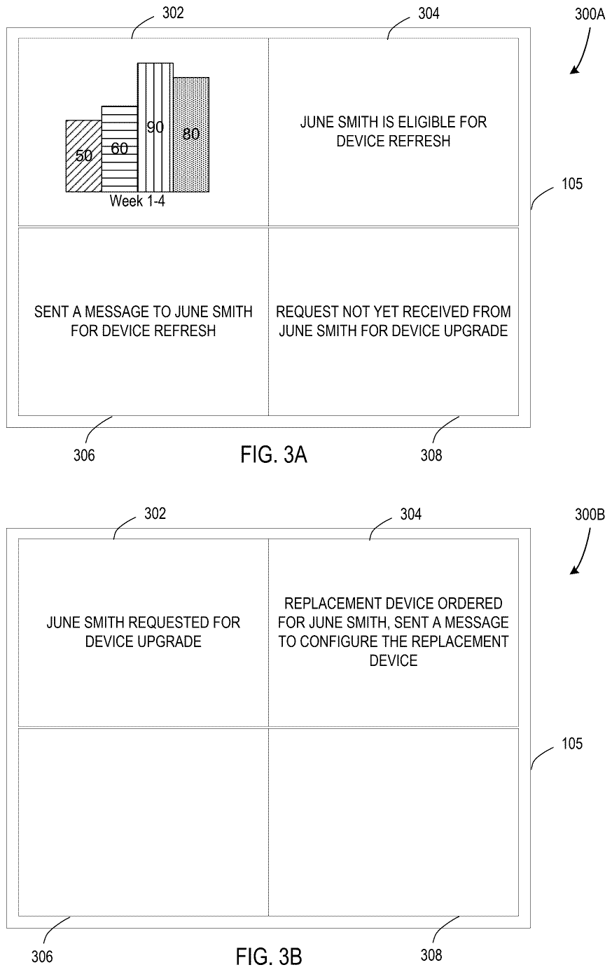

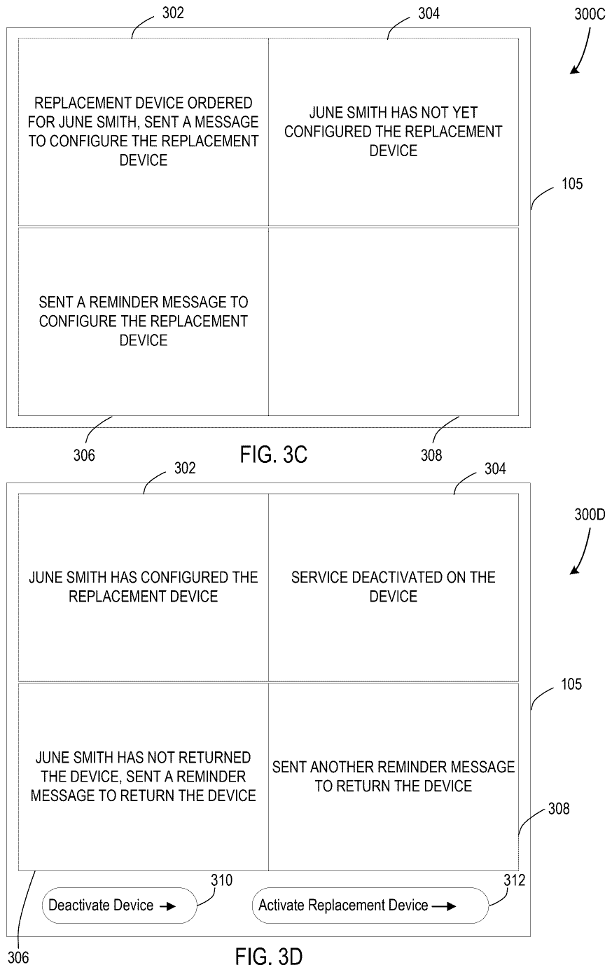

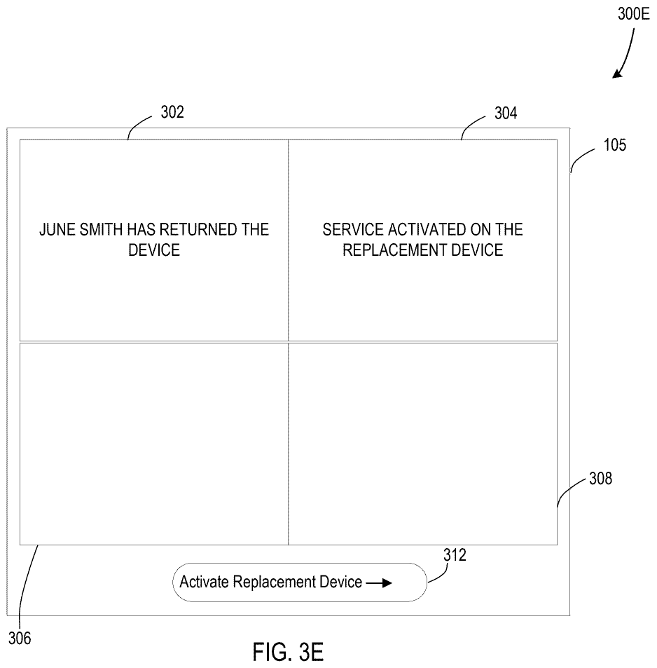

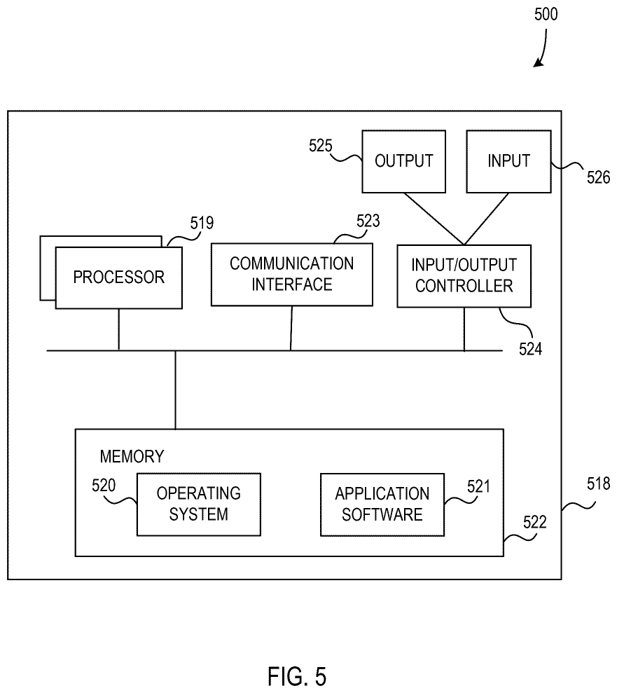

FIG. 1 is a block diagram illustrating an example system 100 for enhancing device security by automating device refresh. The system 100 includes a computing device 102 (e.g., the computing apparatus of FIG. 5) comprising a processor 104, and a memory 106 storing program code 108 that upon execution by the processor 104 causes the processor 104 to obtain identification data 110 associated with a device 118 eligible for refresh. The identification data 110 is obtained from a refresh database 122 via a network 132 (e.g., an intranet, the Internet, a cellular network, other wireless network, other wired network, or the like). Alternatively, the refresh database 122 is directly accessible to the computing device 102. The refresh database 122 is populated by using machine learning and AI for evaluating device health, usage patterns, and security status to determine when the device 118 is eligible for refresh. The identification data 110 includes a unique identifier associated with the device (e.g., International Mobile Equipment Identity (IMEI) number of a Global System for Mobile communication (GSM) phone), a first name of the user, a last name of the user, and/or a unique identifier associated with the user (e.g., an e-mail address). The computing device 102 comprises a user interface (UI) 105. Some examples of the UI 105 are shown in FIG. 3A-3E).

A first message is automatically sent to a user 120 associated with the device 118 eligible for refresh. The first message includes step-by-step instructions to the user 120 to upgrade the device 118 eligible for refresh. The first message is personalized for the user 120 based on the identification data 110 (e.g., by addressing the user 120 by first and or last name). The processor 104 automatically determines, from upgrade data 112 obtained from an upgrade database 124, whether a request has been received from the user 120 to upgrade the device 118 within a first predetermined time period (e.g., one week, one month, etc.) of sending the first message. In some examples, the processor 104 periodically fetches upgrade data 112 associated with users who have requested for upgrade from upgrade database 124 via the network 132. In some other examples, the upgrade data 112 is automatically pushed, via the network 132, to the computing device 102 whenever a user (e.g., user 120) requests for upgrading the device 118 with a replacement device. In this way, the computing and networking resources usage of the computing device 102 is reduced, improving the functioning of the underlying computing device 102.

Upon determining that a request has not been received from the user 120 to upgrade the device 118, a first periodic reminder message is automatically sent to the user 120 for the first predetermined time period. The first periodic reminder message includes the step-by-step instructions to the user 120 to upgrade the device 118. Upon determining that a request has been received from the user 120 to upgrade the device 118, a second message is automatically sent to the user 120. The second message includes step-by-step instructions to configure a replacement device that is ordered as replacement to the device 118 for the user 120. In some examples, the processor 104 forwards the request for the replacement device to a third-party service provider 130 that orders the replacement device for the user 120. The computing device 102 communicates only a portion of the identification data 110 (e.g., only first and last name of the user 120 and an address of the user 120 to which the replacement device is to be shipped) to the third-party service provider 130 along with the forwarded request for the replacement device. In some examples, the computing device 102 is notified when the user 120 receives the replacement device. In this example, the second message including the step-by-step instructions to configure the replacement device is sent to the user 120, almost at the same time or within a particular time period (e.g., within one hour, 24 hours), when the user 120 has received the replacement device. This increases the likelihood of the user 120 configuring the replacement device. In some examples, the step-by-step instructions in the second message include instructions for returning the device 118.

The processor 104 automatically determines, from enrollment data 114 obtained from an enrollment database 126 via an enrollment API, whether the user 120 has configured the replacement device within a second predetermined time period (e.g., one week, one month, etc.) of sending the second message. In some examples, the processor 104 fetches enrollment data 114 from an enrollment database 126 having information about users who have configured their replacement devices via the network 132. In some other examples, the enrollment data 114 is automatically pushed, via the network 132, to the computing device 102 whenever a user (e.g., user 120) configures the replacement device. In this way, the computing and networking resources usage of the computing device 102 is reduced, improving the functioning of the underlying computing device 102.

Upon determining that the user 120 has not configured the replacement device, a second periodic reminder message is automatically sent to the user 120 for the second predetermined time period. The second periodic reminder message includes the step-by-step instructions to configure the replacement device and instructions for returning the device 118. For example, the instructions to return the device 118 include a QR code that upon scanning provides a location and directions to a third-party service provider 130 where the device 118 is to be returned. The QR code is dynamically generated for the user 120 providing the location and direction to the third-party service provider 130 nearest to the user 120 or on the way of routine commute of the user 120.

The processor 104 automatically determines (e.g., upon determining that the user 120 has configured the replacement device), from returned device data 116 obtained from a returned device database 128, whether the user 120 has returned the device 118 within a third predetermined time period (e.g., one week, one month, etc.) of sending the second message. In some examples, the processor 104 fetches, via the network 132, returned device data 116 from the returned device database 128 having information about users who have returned their devices. In some other examples, the returned device data 116 is automatically pushed, via the network 132, to the computing device 102 whenever a user (e.g., user 120) returns the device. In this way, the computing and networking resources usage of the computing device 102 is reduced, improving the functioning of the underlying computing device 102.

Upon determining that the user 120 has returned the device 118 within the third predetermined time period, the processor 104 automatically causes activation of a service on the replacement device and upon determining that the user 120 has not returned the device 118 within the third predetermined time period, the processor 104 automatically causes deactivation of the service on the device 118. Automatically causing activation of the service on the replacement device comprises enabling access to the replacement device for the user and automatically causing deactivation of the service on the device comprises disabling access to the device for the user. In some examples, the service is activated and/or deactivated by the computing device 102. In other examples, the service is provided by a third-party service provider 130 and this third-party service provider 130 is instructed by the computing device 102 to activate and/or deactivate the service on the replacement device and/or the device 118 respectively.

In this way, examples of the disclosure ensure time-bound implementation of device refresh. Any user (such as user 120) who does not adhere to the timelines, is penalized with deactivation of the service on their device (e.g., device 118). This ensures that the organization does not has any device with activated service that does not follow the security standards and/or guidelines laid out by the organization for the devices to be used.

While the refresh database 122, upgrade database 124, enrollment database 126, and returned device database 128 are shown distributed over the network 132, in some examples, these database 122-128 are stored on the same storage infrastructure. The databases 122-128 may be under control of different entities such as the different third-party service providers 130 (e.g., first third-party service provider, second third-party service provider, and the like). In some examples, these databases 122-128 may be implemented using spreadsheets that may be populated by the different entities.

In some examples, the first message, the first periodic reminder message, the second message, and the second periodic reminder message are sent via one or more of electronic mail (e-mail), short messaging service (SMS), and social media messaging service. The predetermined time periods are same or different. For example, two or more of the first predetermined time period, the second predetermined time period, and the third predetermined time period are same. The first predetermined time period is for the user to request for upgrading the device after the device is eligible for refresh (e.g., after the first message is sent to the user that the device is eligible for refresh). The second predetermined time period is for the user to configure the replacement device (e.g., after the device is delivered to the user). The third predetermined time period is for the user to return the device (e.g., after the replacement device has been configured and/or the service is activated on the replacement device). Notably, the predetermined time periods are for the user 120 to act as the computing device 102 performs operations in real-time (e.g., send the first message to the user 120 as soon as the device 118 becomes eligible for refresh, and the like).

In some examples, a frequency of the first periodic reminder message is configurable during the first predetermined time period and a frequency of the second periodic reminder message is configurable during the second predetermined time period. For example, first four first periodic reminder messages are sent every week and thereafter next two first periodic reminder messages are sent after fifteen days, followed by next two first periodic reminder messages being sent after a month. Similar or different frequency may be followed for the second periodic reminder messages. Following a different frequency for the first periodic reminder message and the second periodic reminder message is within scope of this disclosure.

The device 118 that is to be refreshed is one of a mobile phone, laptop, tablet, and the like. In some examples, the service is provided by a first third-party service provider, the replacement device is provided by a second third-party service provider, and the device 118 is returned to a third third-party service provider. The computing device 102 communicates, via the network 132, with the first third-party service provider, the second third-party service provider, and the third third-party service provider via APIs. The first third-party service provider, the second third-party service provider, and the third third-party service provider are different from each other in some examples.

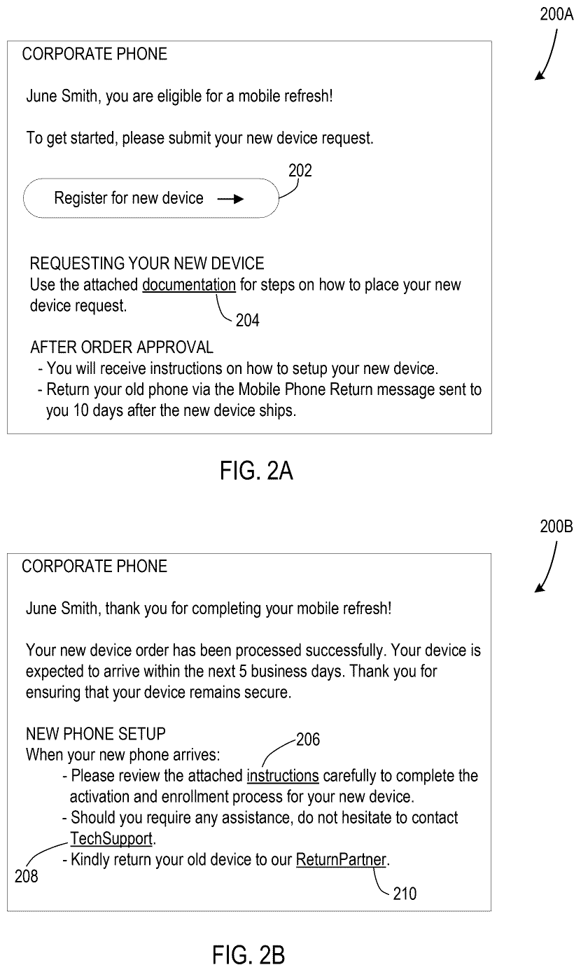

FIG. 2A is a block diagram illustrating an example notification 200A notifying a user eligible for a device refresh. The notification 200A comprises information for the user about eligibility for device refresh and UI elements such as 202, 204 (e.g., as hyperlinks, attachments, and the like). When the user selects a UI element 202, a request for a new / replacement device is submitted. In some examples, the user may be asked to provide a selection of the replacement device from a list of devices available for replacement upon selection of the UI element 202. A UI element 204 may be provided to access documentation for steps to place replacement device request and other steps that will be followed for providing the replacement device along with timeline.

FIG. 2B is a block diagram illustrating an example notification 200B notifying a user with instructions to enroll the replacement device and instructions to return the old device. The notification 200B comprises information for the user about processing of the request for device refresh and timeline for the replacement device to be delivered. The notification comprises UI elements such as 206, 208, 210 (e.g., as hyperlinks, attachments, and the like). Upon selecting any of the UI elements 202-210, user is provided with more information or instructions to be followed for the device refresh or access to a third-party service provider for a further step (e.g., for technical support, for device return, and the like).

FIG. 3A-3E are an example user interface 300A-300E (e.g., UI 105) for tracking automated device refresh. The UI 300A-300E are shown with four UI portions 302, 304, 306, and 308. More or lesser number of UI portions are within scope without deviating from aspects of the disclosure.

A user such as an administrator from an organization accesses the UI 105 provided by the computing device 102. The UI portion 302 displays a bar chart (or some other way of displaying e.g., pie chart) illustrating the number of devices eligible for refresh each week (e.g., weeks 1-4, or some other time period). In some examples, first few intervals (e.g., first two weeks having counts 50 and 60) may be actual count of devices that were eligible for refresh (e.g., during previous weeks), one interval (e.g., a week having count 90) may be actual count of devices that are eligible for refresh (e.g., during current week) and the last few intervals (e.g., last week having count 80) may be projected count of devices that will be eligible for refresh (e.g., during coming weeks).

In some examples, when the administrator drills down on the devices eligible for refresh during last week (having count 60) and wants to see the status of device refresh for a particular device (e.g., of a user June Smith), the UI elements 304-308 are updated to display the current status for the device refresh. For example, UI element 304 shows “JUNE SMITH IS ELIGIBLE FOR DEVICE REFRESH”, UI element 306 shows “SENT A MESSAGE TO JUNE SMITH FOR DEVICE REFRESH”, and UI element 308 shows “REQUEST NOT YET RECEIVED FROM JUNE SMITH FOR DEVICE UPGRADE”.

If the current status of device refresh is updated (e.g., when the UI 300A is being displayed and the user requests for device upgrade), the UI 300B is displayed as illustrated in FIG. 3B. For example, the UI elements 302-308 are updated such as UI element 302 shows “JUNE SMITH REQUESTED FOR DEVICE UPGRADE”, UI element 304 shows “REPLACEMENT DEVICE ORDERED FOR JUNE SMITH, SENT A MESSAGE TO CONFIGURE THE REPLACEMENT DEVICE”, and UI elements 306-308 may or may not display any information. It may be observed that while the user has requested for device upgrade (e.g., as shown in UI element 302), UI element is auto-displayed in real-time e.g., instructions to order the replacement device for this user is provided to a third-party and a message to configure the replacement device is sent to the user automatically.

If the current status of device refresh is updated (e.g., when the UI 300B is being displayed and the device is delivered to the user), the UI 300C is displayed as illustrated in FIG. 3C. For example, the UI elements 302-308 are updated such as UI element 302 shows “REPLACEMENT DEVICE ORDERED FOR JUNE SMITH, SENT A MESSAGE TO CONFIGURE THE REPLACEMENT DEVICE”, UI element 304 shows “JUNE SMITH HAS NOT YET CONFIGURED THE REPLACEMENT DEVICE, UI element 306 shows “SENT A REMINDER MESSAGE TO CONFIGURE THE REPLACEMENT DEVICE”, and UI element 308 may or may not display any information. It may be observed that the computing device 102 automatically receives information about delivery of the replacement device to the user 120 and the UI 300B is automatically updated to UI 300C.

If the current status of device refresh is updated (e.g., when the UI 300C is being displayed and the user has configured the replacement device), the UI 300D is displayed as illustrated in FIG. 3D. For example, the UI elements 302-308 are updated such as UI element 302 shows “JUNE SMITH HAS CONFIGURED THE REPLACEMENT DEVICE”, UI element 304 shows “SERVICE DEACTIVATED ON THE DEVICE”, UI element 306 shows “JUNE SMITH HAS NOT RETURNED THE DEVICE, SENT A REMINDER MESSAGE TO RETURN THE DEVICE”, and UI element 308 shows “SENT ANOTHER REMINDER MESSAGE TO RETURN THE DEVICE”. It may be observed that the computing device 102 automatically receives information about configuring the replacement device by the user 120 and the UI 300C is automatically updated to UI 300D. The UI 300D additionally displays UI elements 310 and 312 e.g., for deactivating the device and activating the replacement device respectively. In some examples, the activation and/or deactivation of a device is performed automatically and UI elements 310-312 may not be displayed. In some other examples, the activation and/or deactivation of a device is performed upon receiving a selection from the administrator.

If the current status of device refresh is updated (e.g., when the UI 300D is being displayed and the user has returned the device), the UI 300E is displayed as illustrated in FIG. 3E. For example, the UI elements 302-308 are updated such as UI element 302 shows “JUNE SMITH HAS RETURNED THE DEVICE”, UI element 304 shows “SERVICE ACTIVATED ON THE REPLACEMENT DEVICE”, and UI elements 306-308 may or may not display any information. The UI 300E additionally displays UI element 312, for example for activating the replacement device. In some examples, the activation of the replacement device is performed automatically and UI element 312 may not be displayed. It may be observed that the UI element 310 (shown in FIG. 3D) is not shown in UI 300E because the device is already deactivated. UI 300A-300E may display information other than the ones illustrated in FIG. 3A-3E without deviating from aspects of the disclosure.

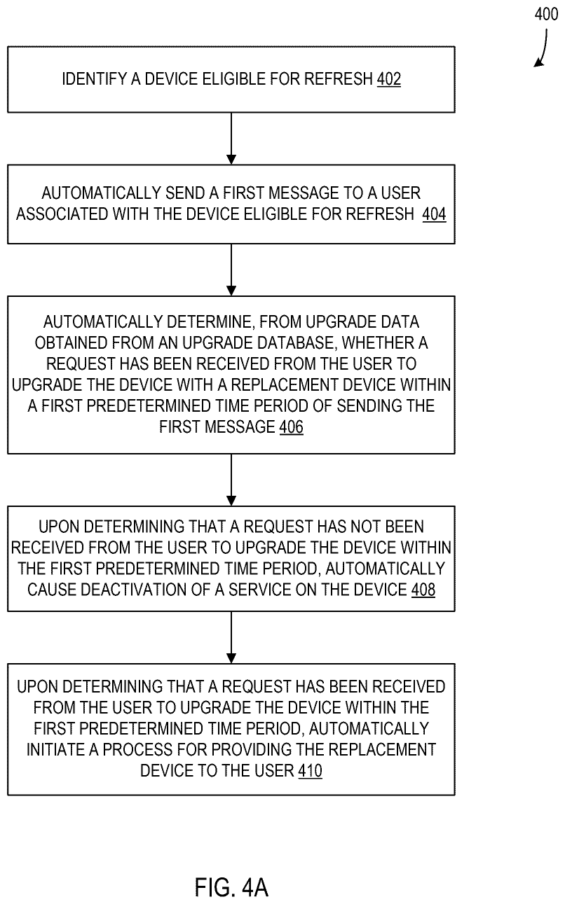

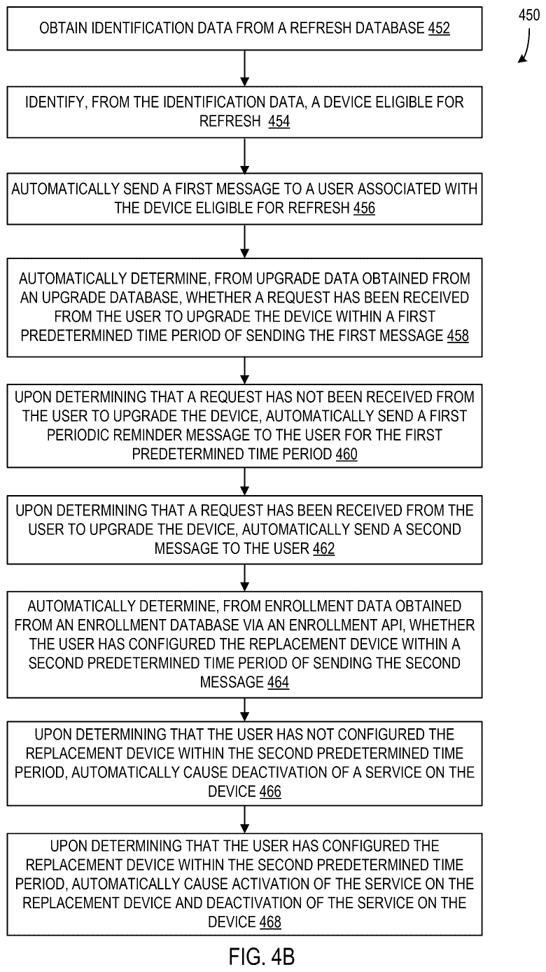

FIG. 4A is a flowchart illustrating an example method 400 for enhancing device security by automating device refresh. At 402, a device eligible for refresh is identified. At 404, a first message is automatically sent to a user associated with the device eligible for refresh. The first message includes step-by-step instructions to the user to upgrade the device eligible for refresh. At 406, it is automatically determined, from upgrade data obtained from an upgrade database, whether a request has been received from the user to upgrade the device with a replacement device within a first predetermined time period of sending the first message. At 408, upon determining that a request has not been received from the user to upgrade the device within the first predetermined time period, deactivation of a service on the device is automatically caused. At 410, upon determining that a request has been received from the user to upgrade the device within the first predetermined time period, a process for providing the replacement device to the user is automatically initiated.

In some examples, the method 400 further comprises automatically sending a first periodic reminder message to the user for the first predetermined time period, the first periodic reminder message including the step-by-step instructions to the user to upgrade the device; upon determining that a request has been received from the user to upgrade the device, automatically sending a second message to the user, the second message including step-by-step instructions to configure the replacement device that is provided as replacement to the device for the user; automatically determining, from enrollment data obtained from an enrollment database via an enrollment API, whether the user has configured the replacement device within a second predetermined time period; upon determining that the user has not configured the replacement device, automatically sending a second periodic reminder message to the user for the second predetermined time period, the second periodic reminder message including the step-by-step instructions to configure the replacement device; automatically determining, from returned device data obtained from a returned device database, whether the user has returned the device within a third predetermined time period; upon determining that the user has returned the device within the third predetermined time period, automatically causing activation of the service on the replacement device; and upon determining that the user has not returned the device within the third predetermined time period, automatically causing deactivation of the service on the device.

FIG. 4B is a flowchart illustrating an example method 450 for enhancing device security by automating device refresh. At 452, identification data is obtained from a refresh database. At 454, a device eligible for refresh is identified from the identification data. At 456, a first message is automatically sent to a user associated with the device eligible for refresh. The first message includes step-by-step instructions to the user to upgrade the device eligible for refresh. At 458, it is automatically determined, from upgrade data obtained from an upgrade database, whether a request has been received from the user to upgrade the device within a first predetermined time period of sending the first message. At 460, upon determining that a request has not been received from the user to upgrade the device, a first periodic reminder message is automatically sent to the user for the first predetermined time period. The first periodic reminder message includes the step-by-step instructions to the user to upgrade the device. At 462, upon determining that a request has been received from the user to upgrade the device, a second message is automatically sent to the user. The second message includes step-by-step instructions to configure a replacement device that is ordered for the user. At 464, it is automatically determined, from enrollment data obtained from an enrollment database via an enrollment API, whether the user has configured the replacement device within a second predetermined time period of sending the second message. At 466, upon determining that the user has not configured the replacement device within the second predetermined time period, automated deactivation of a service on the device is caused. At 468, upon determining that the user has configured the replacement device within the second predetermined time period, automated activation of the service on the replacement device and deactivation of the service on the device is caused. In this example, return of the device may not be necessary and the user may use the device for some other purposes. Because the service is deactivated on the device, it does not pose security threats.

In some examples, if even after some predetermined number of reminder messages (e.g., four reminders) the user 118 has not acted on the notification (e.g., the first message notifying eligibility of the user for device refresh, the second message notifying instructions to configure the replacement device, and/or a third message notifying instructions to return the device 120), the user's manager is also copied on the reminder message. In some examples, periodic (e.g., daily) reporting of: (1) the devices that become eligible for refresh, (2) users who have acted on the notification and requested for device upgrade/refresh, (3) users who have received the replacement device, (4) users who have configured their device, (5) users who have returned the device, (6) devices that have been deactivated, (7) replacement devices that have been activated, etc. are provided to the responsible authorities in the organization.

The service that is deactivated and/or activated may be cellular service, network service, biometric service, etc. on the device 118 and/or replacement device respectively. For example, if the user 120 does not follow the timelines specified in the notification (or if the return of the device 118 is not required), disabling the biometric service on the device 118 will prevent the user 120 from authenticating and/or authorizing to access organizational resources (e.g., computing resources, building access etc.). However, other services on the device 118 can continue to function. In this way, the device 118 can still be used for other purposes or by some other user (e.g., with lesser resource requirements).

### Exemplary Operating Environment

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the computing apparatus 518. In some examples, enhancing device security by automating device refresh is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium does not include a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system for enhancing device security through device refresh is provided. The system comprises: a processor; and a computer storage device storing computer program code that upon execution by the processor cause the processor to: obtain identification data associated with a device eligible for refresh; automatically send a first message to a user associated with the device eligible for refresh, the first message including step-by-step instructions to the user to upgrade the device eligible for refresh; automatically determine, from upgrade data obtained from an upgrade database, whether a request has been received from the user to upgrade the device within a first predetermined time period of sending the first message; upon determining that a request has not been received from the user to upgrade the device, automatically send a first periodic reminder message to the user for the first predetermined time period, the first periodic reminder message including the step-by-step instructions to the user to upgrade the device; upon determining that a request has been received from the user to upgrade the device, automatically send a second message to the user, the second message including step-by-step instructions to configure a replacement device that is ordered as replacement to the device for the user; automatically determine, from enrollment data obtained from an enrollment database via an enrollment API, whether the user has configured the replacement device within a second predetermined time period; upon determining that the user has not configured the replacement device, automatically send a second periodic reminder message to the user for the second predetermined time period, the second periodic reminder message including the step-by-step instructions to configure the replacement device; automatically determine, from returned device data obtained from a returned device database, whether the user has returned the device within a third predetermined time period; upon determining that the user has returned the device within the third predetermined time period, automatically cause activation of a service on the replacement device; and upon determining that the user has not returned the device within the third predetermined time period, automatically cause deactivation of the service on the device.

An example computer-implemented method for enhancing device security through device refresh is provided. The computer-implemented method comprises: identifying a device eligible for refresh; automatically sending a first message to a user associated with the device eligible for refresh, the first message including step-by-step instructions to the user to upgrade the device eligible for refresh; automatically determining, from upgrade data obtained from an upgrade database, whether a request has been received from the user to upgrade the device with a replacement device within a first predetermined time period of sending the first message; upon determining that a request has not been received from the user to upgrade the device within the first predetermined time period, automatically cause deactivation of a service on the device; and upon determining that a request has been received from the user to upgrade the device within the first predetermined time period, automatically initiating a process for providing the replacement device to the user.

An example computer storage medium for enhancing device security through device refresh is provided. The computer storage medium stores computer program code that upon execution by the processor cause the processor to: obtain identification data from a refresh database; identify, from the identification data, a device eligible for refresh; automatically send a first message to a user associated with the device eligible for refresh, the first message including step-by-step instructions to the user to upgrade the device eligible for refresh; automatically determine, from upgrade data obtained from an upgrade database, whether a request has been received from the user to upgrade the device within a first predetermined time period of sending the first message; upon determining that a request has not been received from the user to upgrade the device, automatically send a first periodic reminder message to the user for the first predetermined time period, the first periodic reminder message including the step-by-step instructions to the user to upgrade the device; upon determining that a request has been received from the user to upgrade the device, automatically send a second message to the user, the second message including step-by-step instructions to configure a replacement device that is ordered for the user; automatically determine, from enrollment data obtained from an enrollment database via an enrollment API, whether the user has configured the replacement device within a second predetermined time period of sending the second message; upon determining that the user has not configured the replacement device within the second predetermined time period, automatically cause deactivation of a service on the device; and upon determining that the user has configured the replacement device within the second predetermined time period, automatically cause activation of the service on the replacement device and deactivation of the service on the device.

Alternatively, or in addition to the other examples described herein, examples include any combination of the following:
wherein the first message, the first periodic reminder message, the second message, and the second periodic reminder message are sent via one or more of electronic mail (e-mail), short messaging service (SMS), and social media messaging service
wherein two or more of the first predetermined time period, the second predetermined time period, and the third predetermined time period are same.
wherein the first predetermined time period, the second predetermined time period, and the third predetermined time period are different.
wherein the device is one of a mobile phone, a laptop, and a tablet.
wherein the service is provided by a first third-party service provider, the replacement device is provided by a second third-party service provider, and the device is returned to a third third-party service provider, wherein the system communicates with the first third-party service provider, the second third-party service provider, and the third third-party service provider via APIs, wherein the first third-party service provider, the second third-party service provider, and the third third-party service provider are different from each other.
wherein automatically causing activation of the service on the replacement device comprises enabling access to the replacement device for the user and automatically causing deactivation of the service on the device comprises disabling access to the device for the user.
wherein the identification data comprises one or more of a unique identifier associated with the device, a first name of the user, a last name of the user, and a unique identifier associated with the user.
wherein a frequency of the first periodic reminder message is configurable during the first predetermined time period and a frequency of the second periodic reminder message is configurable during the second predetermined time period.
automatically sending a first periodic reminder message to the user for the first predetermined time period, the first periodic reminder message including the step-by-step instructions to the user to upgrade the device; upon determining that a request has been received from the user to upgrade the device, automatically sending a second message to the user, the second message including step-by-step instructions to configure the replacement device that is provided as replacement to the device for the user; automatically determining, from enrollment data obtained from an enrollment database via an enrollment API, whether the user has configured the replacement device within a second predetermined time period; upon determining that the user has not configured the replacement device, automatically sending a second periodic reminder message to the user for the second predetermined time period, the second periodic reminder message including the step-by-step instructions to configure the replacement device; automatically determining, from returned device data obtained from a returned device database, whether the user has returned the device within a third predetermined time period; upon determining that the user has returned the device within the third predetermined time period, automatically causing activation of the service on the replacement device; and upon determining that the user has not returned the device within the third predetermined time period, automatically causing deactivation of the service on the device.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for detecting fraud transactions in peer-to-peer payments without an intermediary.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer storage device storing computer program code that upon execution by the processor cause the processor to:
obtain identification data associated with a device eligible for refresh;
automatically send a first message to a user associated with the device eligible for refresh, the first message including step-by-step instructions to the user to upgrade the device eligible for refresh;
automatically determine, from upgrade data obtained from an upgrade database, whether a request has been received from the user to upgrade the device within a first predetermined time period of sending the first message;
upon determining that a request has not been received from the user to upgrade the device, automatically send a first periodic reminder message to the user for the first predetermined time period, the first periodic reminder message including the step-by-step instructions to the user to upgrade the device;
upon determining that a request has been received from the user to upgrade the device, automatically send a second message to the user, the second message including step-by-step instructions to configure a replacement device that is ordered as replacement to the device for the user;
automatically determine, from enrollment data obtained from an enrollment database via an enrollment API, whether the user has configured the replacement device within a second predetermined time period;
upon determining that the user has not configured the replacement device, automatically send a second periodic reminder message to the user for the second predetermined time period, the second periodic reminder message including the step-by-step instructions to configure the replacement device;
automatically determine, from returned device data obtained from a returned device database, whether the user has returned the device within a third predetermined time period;
upon determining that the user has returned the device within the third predetermined time period, automatically cause activation of a service on the replacement device; and
upon determining that the user has not returned the device within the third predetermined time period, automatically cause deactivation of the service on the device.

2. The system of claim 1, wherein the first message, the first periodic reminder message, the second message, and the second periodic reminder message are sent via one or more of electronic mail (e-mail), short messaging service (SMS), and social media messaging service.

3. The system of claim 1, wherein two or more of the first predetermined time period, the second predetermined time period, and the third predetermined time period are same.

4. The system of claim 1, wherein the first predetermined time period, the second predetermined time period, and the third predetermined time period are different.

5. The system of claim 1, wherein the device is one of a mobile phone, a laptop, and a tablet.

6. The system of claim 1, wherein the service is provided by a first third-party service provider, the replacement device is provided by a second third-party service provider, and the device is returned to a third third-party service provider, wherein the system communicates with the first third-party service provider, the second third-party service provider, and the third third-party service provider via APIs, wherein the first third-party service provider, the second third-party service provider, and the third third-party service provider are different from each other.

7. The system of claim 1, wherein automatically causing activation of the service on the replacement device comprises enabling access to the replacement device for the user and automatically causing deactivation of the service on the device comprises disabling access to the device for the user.

8. The system of claim 1, wherein the identification data comprises one or more of a unique identifier associated with the device, a first name of the user, a last name of the user, and a unique identifier associated with the user.

9. The system of claim 1, wherein a frequency of the first periodic reminder message is configurable during the first predetermined time period and a frequency of the second periodic reminder message is configurable during the second predetermined time period.

10. A computer-implemented method comprising:
identifying a device eligible for refresh;
automatically sending a first message to a user associated with the device eligible for refresh, the first message including step-by-step instructions to the user to upgrade the device eligible for refresh;
automatically determining, from upgrade data obtained from an upgrade database, whether a request has been received from the user to upgrade the device with a replacement device within a first predetermined time period of sending the first message;
upon determining that a request has not been received from the user to upgrade the device within the first predetermined time period, automatically cause deactivation of a service on the device; and
upon determining that a request has been received from the user to upgrade the device within the first predetermined time period, automatically initiating a process for providing the replacement device to the user.

11. The computer-implemented method of claim 10, wherein the device is one of a mobile phone, a laptop, and a tablet.

12. The computer-implemented method of claim 10, further comprising:
automatically sending a first periodic reminder message to the user for the first predetermined time period, the first periodic reminder message including the step-by-step instructions to the user to upgrade the device;
upon determining that a request has been received from the user to upgrade the device, automatically sending a second message to the user, the second message including step-by-step instructions to configure the replacement device that is provided as replacement to the device for the user;
automatically determining, from enrollment data obtained from an enrollment database via an enrollment API, whether the user has configured the replacement device within a second predetermined time period;
upon determining that the user has not configured the replacement device, automatically sending a second periodic reminder message to the user for the second predetermined time period, the second periodic reminder message including the step-by-step instructions to configure the replacement device;
automatically determining, from returned device data obtained from a returned device database, whether the user has returned the device within a third predetermined time period;
upon determining that the user has returned the device within the third predetermined time period, automatically causing activation of the service on the replacement device; and
upon determining that the user has not returned the device within the third predetermined time period, automatically causing deactivation of the service on the device.

13. The computer-implemented method of claim 12, wherein the first message, the first periodic reminder message, the second message, and the periodic second reminder message are sent via one or more of electronic mail (e-mail), short messaging service (SMS), and social media messaging service.

14. The computer-implemented method of claim 12, wherein two or more of the first predetermined time period, the second predetermined time period, and the third predetermined time period are same.

15. The computer-implemented method of claim 12, wherein the first predetermined time period, the second predetermined time period, and the third predetermined time period are different.

16. The computer-implemented method of claim 12, wherein the service is provided by a first third-party service provider, the replacement device is provided by a second third-party service provider, and the device is returned to a third third-party service provider, wherein the method communicates with the first third-party service provider, the second third-party service provider, and the third third-party service provider via APIs, wherein the first third-party service provider, the second third-party service provider, and the third third-party service provider are different from each other.

17. A computer storage device storing computer program code that upon execution by the processor cause the processor to:
obtain identification data from a refresh database;
identify, from the identification data, a device eligible for refresh;
automatically send a first message to a user associated with the device eligible for refresh, the first message including step-by-step instructions to the user to upgrade the device eligible for refresh;
automatically determine, from upgrade data obtained from an upgrade database, whether a request has been received from the user to upgrade the device within a first predetermined time period of sending the first message;
upon determining that a request has not been received from the user to upgrade the device, automatically send a first periodic reminder message to the user for the first predetermined time period, the first periodic reminder message including the step-by-step instructions to the user to upgrade the device;
upon determining that a request has been received from the user to upgrade the device, automatically send a second message to the user, the second message including step-by-step instructions to configure a replacement device that is ordered for the user;
automatically determine, from enrollment data obtained from an enrollment database via an enrollment API, whether the user has configured the replacement device within a second predetermined time period of sending the second message;
upon determining that the user has not configured the replacement device within the second predetermined time period, automatically cause deactivation of a service on the device; and
upon determining that the user has configured the replacement device within the second predetermined time period, automatically cause activation of the service on the replacement device and deactivation of the service on the device.

18. The computer storage device of claim 17, wherein the device is one of a mobile phone, a laptop, and a tablet.

19. The computer storage device of claim 17, wherein the first message, the first periodic reminder message, and the second message are sent via one or more of electronic mail (e-mail), short messaging service (SMS), and social media messaging service.

20. The computer storage device of claim 17, wherein the service is provided by a first third-party service provider and the replacement device is provided by a second third-party service provider, wherein the computer program code upon execution by the processor causes the processor to communicate with the first third-party service provider, and the second third-party service provider via APIs, wherein the first third-party service provider is different from the second third-party service provider.
